(19) United States
(12) Patent Application Publication
(10) Pub. No.: US 2023/0148038 A1
(43) Pub. Date: May 11, 2023

(54) METHOD FOR RENDERING GIS POINT DATA, COMPUTER DEVICE AND STORAGE MEDIUM

(71) Applicant: PING AN TECHNOLOGY (SHENZHEN) CO., LTD., Shenzhen, Guangdong (CN)

(72) Inventors: Li HOU, Shenzhen, Guangdong (CN); Xiang LIU, Shenzhen, Guangdong (CN)

(21) Appl. No.: 17/613,457

(22) PCT Filed: Aug. 28, 2020
(86) PCT No.: PCT/CN2020/111978

§ 371 Date: Nov. 22, 2021

(30) Foreign Application Priority Data
Jul. 27, 2020 (CN) 202010733018.8

(51) Int. Cl. G06T 11/00; G06T 3/40; G06F 16/29

(52) U.S. Cl. CPC G06T 11/00; G06T 3/40; G06F 16/29

(57) ABSTRACT

A method for rendering GIS point data is provided, this method includes: receiving a rendering instruction that carries a geographic region range to be rendered; selecting GIS point data corresponding to the geographic region range; generating, by execution of a canvas object generation thread, a canvas object corresponding to the selected GIS point data; and displaying the generated canvas object on a screen by execution of a display thread, continuing to obtain a remaining GIS point data, and generating a canvas object corresponding to the remaining GIS point data by execution of the canvas object generation thread, when or after the canvas object is displayed.

### CROSS-REFERENCE TO RELATED APPLICATIONS

This application is a National Stage of PCT Application No. PCT/CN2020/111978 filed on Aug. 28, 2020, which claims priority to Chinese patent application No. 202010733018.8 filed with CNIPA on Jul. 27, 2020 and entitled “method and device for rendering GIS point data, computer device and storage medium”, the contents each of which are incorporated herein by reference thereto.

### TECHNICAL FIELD

The present application relates to the technical field of artificial intelligence, and particularly relates to a method for rendering GIS point data, a device for rendering GIS point data, a computer device and a storage medium.

### BACKGROUND

With the development of information technology, geographic information system technology is developed, the GIS (Geographic Information System) is a computer system for collecting, storing, managing, processing, analyzing, displaying and applying geographic data. A canvas object in a browser is an HTML5 element for drawing an image using a script computer language, which is commonly referred to as a canvas object, the canvas object is used for rendering an image in a browser, point data is composed of one or more pairs of coordinates and is a set of discrete spatial points with geographic coordinate information.

In the conventional technology, GIS point data of the browser is rendered by reading the identifier and the spatial geographic coordinates that are common to the GIS point data in various formats, then, the corresponding graphic file is obtained, the identifier and the spatial geographic coordinate, and the graphic file are packaged into the canvas object, finally, canvas objects in the range of the screen are rendered in batches merely.

However, in the above-described method, all canvas objects need to be calculated first, then, whether these canvas objects are in the range of the screen or not is determined, if one canvas object is not in the range of the display, this canvas object is not displayed, the canvas objects which are in the range of the current screen are displayed merely, in this way, time is spent on calculating redundant canvas objects, and a display efficiency is reduced.

### SUMMARY

According to the various embodiments of the present application, a method for rendering GIS point data, a device for rendering GIS point data, a computer device and a storage medium are provided.

The method for rendering GIS point data includes steps of:

receiving a rendering instruction that carries a geographic region range to be rendered;

selecting GIS point data corresponding to the geographic region range;

generating a canvas object corresponding to the selected GIS point data by execution of a canvas object generation thread; and

displaying the generated canvas object on a screen by execution of a display thread, and continuing to obtain a remaining GIS point data, and generating a canvas object corresponding to the remaining GIS point data by execution of the canvas object generation thread, when or after the canvas object is displayed.

A computer device, including a memory and one or a plurality of processor(s), the memory stores a computer readable instruction, that, when being executed by the one or plurality of processor(s), causes the one or plurality of processor(s) to perform following steps of:

receiving a rendering instruction that carries a geographic region range to be rendered;

selecting GIS point data corresponding to the geographic region range;

generating a canvas object corresponding to the selected GIS point data by execution of a canvas object generation thread; and

displaying the generated canvas object on a screen by execution of a display thread, and continuing to obtain a remaining GIS point data and generating a canvas object corresponding to the remaining GIS point data by execution of the canvas object generation thread, when or after the canvas object is displayed.

A computer readable storage medium which stores a computer readable instruction, that, when being executed by one or plurality of processor(s), cause the one or plurality of processor(s) to perform following steps of:

receiving a rendering instruction that carries a geographic region range to be rendered;

selecting GIS point data corresponding to the geographic region range;

generating, by execution of a canvas object generation thread, a canvas object corresponding to the selected GIS point data; and

displaying the generated canvas object on a screen by execution of a display thread, and continuing to obtain a remaining GIS point data and generating a canvas object corresponding to the remaining GIS point data by execution of the canvas object generation thread when or after the canvas object is displayed.

In the method and device for rendering GIS point data, the computer device and the storage medium, the corresponding canvas object is preferably generated according to the geographic region range to be displayed on the screen, and is displayed, and the remaining GIS point data is continued to be obtained and the canvas object corresponding to the remaining GIS point data is generated by execution of the canvas object generation thread, after the canvas object is displayed, such that a displaying efficiency is improved.

The details of one or more embodiments of the present application are described in the accompanying drawings and the description below. Other features and advantages of the present application will become apparent from the description, the accompanying drawings and the claims.

### BRIEF DESCRIPTION OF THE DRAWINGS

In order to describe the embodiments of the present application more clearly, a brief introduction regarding the accompanying drawings that need to be used for describing the embodiments of the present application is given below; it is apparent that the accompanying drawings described below are only some embodiments of the present application, a skilled person in the art can also obtain other drawings according to the current drawings without paying creative labor.

FIG. 1 illustrates a schematic flow diagram of a method for rendering GIS point data according to one or a plurality of embodiment(s) of the present application;

FIG. 2 illustrates a schematic diagram of distribution of GIS point data according to one or a plurality of embodiment(s) of the present application;

FIG. 3 illustrates a structural block diagram of a terminal device according to one embodiment of the present application.

### DESCRIPTION OF THE EMBODIMENTS

In order to make the technical solutions and the advantages of the present application be clearer and more understandable, the present application will be further described in detail below with reference to the accompanying figures and the embodiments. It will be appreciated that the embodiments described in detail herein are merely intended to illustrate but not to limit the present application.

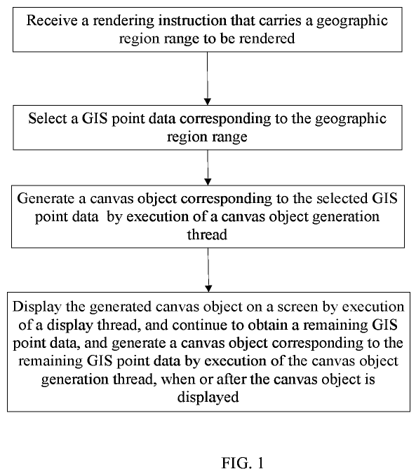

In one embodiment, as shown in FIG. 1, a method for rendering GIS (Geographic Information System) point data is provided. The embodiment is described by taking the method applied in a terminal device as an example. It should be understood that, this method may also be applied in a server and may also be applied in a system including the terminal device and the server, and is realized by the interaction between the terminal device and the server. In this embodiment, the method includes the following steps:

At step S102, receive a rendering instruction that carries a geographic region range to be rendered.

Specifically, the rendering instruction is an instruction input to a display terminal by the user, such as an instruction of displaying a certain type of map by clicking a button, or an instruction for zooming-in a map or zooming-out a map, or an instruction of adjusting a display range of a map by moving the map. The rendering instruction carries a geographic region range of a map to be displayed. For example, if the rendering instruction is the instruction of displaying a certain type of map by clicking a certain button, a complete area planning map such as the whole country or some province is displayed by default; the display terminal determines a relative displacement of a region by obtaining a mouse input displacement corresponding to the zoom-out or zoom-in instruction, and thereby determining a new geographic region range according to the original geographical area range and the relative displacement, if the rendering instruction is the instruction for zooming-in or zooming-out the map; the display terminal determines the relative displacement of the region by acquiring the displacement of the mouse, and thereby determining a new geographic region range according to the original geographical area range and the relative displacement, if the rendering instruction is the instruction of adjusting the display range of the map by moving the map.

At step 104, select a GIS point data corresponding to the geographic region range.

Specifically, the GIS point data may be displayed in various formats such as Excel, CSV and GeoJSON, the display terminal reads GIS point data in the various formats, including location identifiers and geographic location coordinates. In this way, the display terminal may select the corresponding GIS point data (i.e., the GIS point data in the display range) according to the geographic region range and the geographic position coordinates corresponding to the various GIS point data. Moreover, optionally, the step of extracting GIS point data from the files in the various formats may be performed in advance, so that the display terminal may store the extracted GIS point data, which facilitates the subsequent step of selecting the GIS point data corresponding to the geographic region range.

It should be emphasized that, the GIS point data may also be stored in a node of a blockchain so as to further ensure the privacy and the security of the GIS point data.

At step S106, generate a canvas object corresponding the selected GIS point data by execution of a canvas object generation thread.

Specifically, the canvas object generation thread is mainly used for generating a canvas object corresponding to each of the GIS point data, for example, a canvas object of a provincial capital city may be presented by a small star icon, in this way, in the execution of the canvas object generation thread, the display terminal encapsulates the GIS point data and the small star icon to obtain the canvas object representing the provincial capital city. Optionally, the display terminal further needs to acquire a size of the display screen so as to determine a size of the canvas object by determining a ratio of the size of the geographic region range to the size of the current display screen.

At step S108, display the generated canvas object in the screen during execution of a display thread, and continue to obtain the remaining GIS point data and generate corresponding canvas objects corresponding to the remaining GIS point data by execution of the canvas object generation thread, when or after the canvas object is displayed or after the canvas object is displayed.

Specifically, after generating the canvas objects corresponding to the remaining GIS point data, the display terminal displays canvas objects in the current screen in batches to complete display, and when or after displaying the canvas objects, the remaining GIS point data is obtained subsequently and the canvas objects corresponding to the remaining GIS point data are generated by the canvas object generation thread.

According to the method for rendering GIS point data, the corresponding canvas objects are preferentially generated according to the geographic region range to be displayed by the screen, and are displayed simultaneously, the remaining GIS point data is continued to be obtained and the corresponding canvas objects are generated when or after the canvas objects are displayed, such that a display efficiency can be improved.

In one embodiment, a step of continuing to obtain the remaining GIS point data and generate corresponding canvas objects by execution of the canvas object generation thread includes: obtain new GIS point data from the remaining GIS point data in an ascending order of distances from the geographic region range and generate a new canvas object according to the obtained new GIS point data, by execution of the canvas object generation thread.

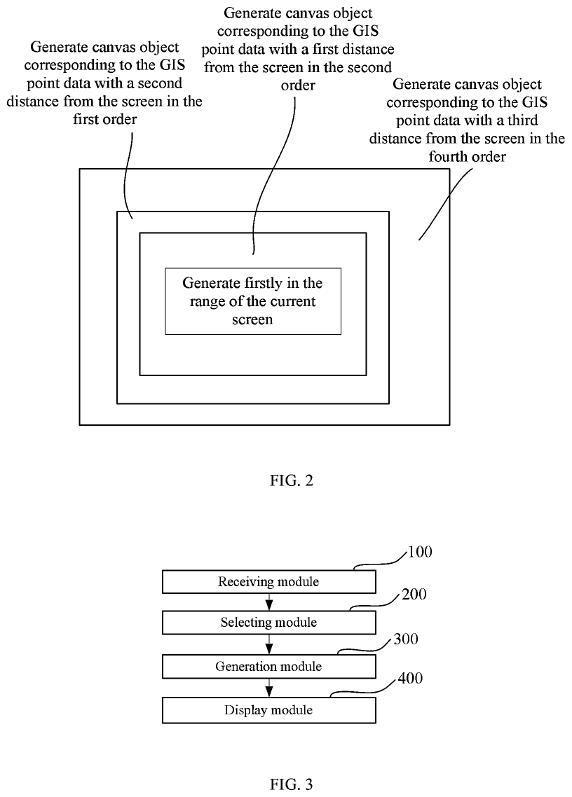

Specifically, the canvas object generation thread may obtain GIS point data in an ascending order of distances from the geographic region range, and generate a canvas object corresponding to the GIS point data, in particular, the display terminal obtains the GIS point data in the ascending order of distances from the geographic region range, and determines a set of classifications to which the GIS point data pertains, if the GIS point data pertains to a set of known classifications, a graphic file corresponding to the set is directly obtained to generate a canvas object; if the GIS point data does not pertains to a set of known classifications, a new set is created, and a graphic file corresponding to the new set is obtained to generate a corresponding canvas object. The detail of the process can be referred to FIG. 2, for example, the canvas object which corresponds to the GIS point data of the geographic region range that corresponds to the current screen area is preferentially generated, then, the GIS point data of the area having a first distance from the screen is obtained, so that a canvas object corresponding to the GIS point data is generated in the second order. Then, the GIS point data of the area having a second distance from the screen is obtained, so that the canvas object corresponding to the GIS point data is generated in the third order. Finally, GIS point data of a region having a third distance from the screen is obtained, so that the corresponding canvas object corresponding to the GIS point data is generated in the fourth order.

This set of classifications herein refers to a set of classified GIS point data, which can be such as a provincial capital city and a non-provincial capital city.

In this embodiment, the GIS point data may be obtained in an ascending order of distances from the geographic region range by execution of the canvas object generation thread, so that the canvas objects corresponding to the GIS point data in the geographic region range are generated and displayed preferentially, then, the GIS point data is continued to be obtained in the ascending order of distances from the geographic region range, and the canvas objects corresponding to the obtained GIS point data are generated, so that displaying of the canvas objects is facilitated.

In one embodiment, a method for generating canvas object includes: classify the obtained GIS point data according to a preset classification; obtain a set corresponding to the related classifications, and select a graphic file corresponding to the obtained set; and encapsulate the graphic file with the GIS point data in the corresponding sets to obtain canvas objects.

Specifically, after the GIS point data corresponding to the geographic region range is obtained, the method may further include the step of classifying the selected GIS point data, for example, classifying the GIS point data into provincial capital cities and a non-provincial capital cities, etc. In another embodiment, different classification sets may be obtained by classifying the GIS point data according to a preset classification. In this way, the step of generating the canvas object according to the selected GIS point data by execution of the canvas object generation thread may include: obtain the related classification sets, select a graphic file corresponding to the related classification set, and encapsulate the graphic file with each GIS point data in the corresponding classification sets to obtain the canvas object.

In this embodiment, the GIS point data is classified firstly, so that the graphic files corresponding to the classifications of the GIS point data are obtained, when a canvas object needs to be generated, a corresponding graphic file is directly obtained.

In one embodiment, after displaying the generated canvas object on the screen during execution of the display thread, the method further includes: store the canvas object displayed in the screen in a memory. After selecting the GIS point data corresponding to the geographic region range, the method further includes: determine whether the GIS point data corresponding to the geographic region range corresponds to the canvas object stored in the memory; directly read the corresponding canvas object from the memory if the GIS point data corresponding to the geographic region range corresponds to the canvas object stored in the memory; or continue to generate the canvas object corresponding to the selected GIS point data by execution of the canvas object generation thread.

Specifically, after displaying of the canvas object is completed, the display terminal stores the generated canvas object in the memory, so that the display terminal determines whether the GIS point data corresponding to the geographic region range corresponds to the canvas object stored in the memory after the corresponding GIS point data is selected according to the geographic region range, if the GIS point data corresponds to the canvas object stored in the memory, the corresponding canvas object is directly read from the memory; the step of continuing to generate the canvas object corresponding to the selected GIS point data by execution of the canvas object generation thread is continued to be performed.

This embodiment relates to displaying of incremental data, that is, the GIS point data that has been displayed is pre-stored in the memory, so that after the map is zoomed-out or moved, whether a corresponding canvas object of the GIS point that corresponds to the new geographic region range has been generated can be determined first, if the corresponding canvas object of the GIS point is generated, this new generated canvas object is directly obtained, and there is no need to generate canvas object again, so that the efficiency of rendering GIS point data is improved.

In one embodiment, the step of determining whether the GIS point data corresponding to the geographic region range corresponds to the canvas object stored in the memory includes: compare the geographic region range with a geographic region range that corresponds to the stored canvas object to obtain an overlapped region; determine whether there is GIS point data in the overlapped region, extract a canvas object corresponding to the GIS point data in the overlapped region from the memory, and continue to query whether there exists a canvas object corresponding to a GIS point data in an unoverlapped region in the memory.

Specifically, in this embodiment, the step of determining whether the GIS point data corresponding to the geographic region range corresponds to the canvas objects stored in the memory can be realized by: obtaining new geographic region range after operation, comparing the new geographic region range with the geographic region range that corresponds to the stored canvas object to obtain the overlapped region, determining whether there exists GIS point data in the overlapped geographic region, and obtaining the corresponding canvas object stored in the memory according to the overlapped geographic region if there exists the GIS point data in the overlapped geographic region; regarding the unoverlapped region, obtaining GIS point data in the unoverlapped region, and then querying whether there exists a canvas object corresponding to the GIS point data in the memory, directly obtaining the canvas object if there exists the canvas object corresponding to the GIS point data in the memory, or preferentially generating canvas object if there doesn't exist a canvas object corresponding to the GIS point data in the memory.

In this embodiment, regarding the GIS point data in the overlapped region, the canvas object corresponding to the GIS point data in the overlapped region may be directly obtained, however, regarding the GIS point data in the unoverlapped region, the canvas object is obtained by querying the memory, so that the efficiency of rendering GIS point data is improved.

In one embodiment, before determining whether the GIS point data corresponding to the geographic region range corresponds to the canvas object stored in the memory, the method further includes steps of: determine whether all canvas objects corresponding to the GIS point data have been generated; and read the canvas objects corresponding to the GIS point data from the memory directly.

Specifically, the step of determining whether the GIS point data corresponding to the geographic region range corresponds to the canvas object stored in the memory can also be realized by: determining whether all canvas objects corresponding to the GIS point data have been generated, that is, whether generation of all canvas objects corresponding to the GIS point data has been completed by execution of the canvas object generation thread, if the generation of all canvas objects corresponding to the GIS point data has been completed, the corresponding canvas object may be obtained by directly querying the memory, if the generation of all canvas objects corresponding to the GIS point data has not yet been completed, a new geographic region range after the operation is continued to be obtained, and the steps of comparing the two geographic region ranges is performed.

In this embodiment, whether the canvas objects corresponding to all the GIS point data have been generated is determined first, if the canvas objects corresponding to all the GIS point data have been generated, the canvas object corresponding to the GIS point data is directly read from the memory without being generated again, so that the processing efficiency of rendering GIS point data is further improved.

In one embodiment, the method for rendering GIS point data further includes: determine a degree of adjustment corresponding to the zoom instruction after a zoom instruction is received; obtain a original graphic size of each of graphic files corresponding to the various sets; adjust the original graphic size according to the degree of adjustment to obtain a new graphic file; and replace the original graphic file with the new graphic file.

Specifically, due to the zoom-in or zoom-out operation on the map, the size of the graphic in the graphic file in the corresponding canvas object needs to be changed, therefore, when the display terminal receives the zoom-in or zoom-out instruction, a degree of adjustment of image corresponding to the zoom-in or zoom-out instruction is obtained, in particular, the degree of adjustment of image equalizes a division of the original display size by the new display size, then, the original graphic size of the graphic file corresponding to each classified set is obtained, then, the new graphic file is obtained according to the degree of adjustment of image and the original graphic size of the graphic file, the new graphic file is obtained according to the size of the new graphic file, and the graphic file corresponding to each of the related sets of classifications (i.e., the sets of classifications related to the regions corresponding to the various GIS point data that can be displayed by the display) is replaced with the new graphic file, and the new graphic file is displayed, so that the display efficiency of canvas object is improved.

The blockchain in the embodiments is directed to a new application mode of computer technologies such as distributed data storage, point-to-point transmission, consensus mechanism, encryption algorithm, and the like. Blockchain is essentially a decentralized database which is constituted of a series of data blocks, and the blockchain is generated by associating these data blocks using cryptographic methods, each of these data blocks contains information of a batch of network transactions which are used for verifying the validity (anti-counterfeiting) of the information and generating a next data block. The blockchain may include a blockchain bottom layer platform, a platform product service layer, and an application service layer, etc.

It should be understood that, although the steps in the flow diagram of FIG. 1 are displayed sequentially according to the indication of the arrows, these steps are not necessarily performed in the order indicated by the arrows. The execution of these steps is not strictly limited unless being explicitly stipulated herein, and these steps can be performed in other order. Moreover, at least a part of the steps in FIG. 1 can include a plurality of steps or phases, and these steps or phases are not necessarily performed at the same time, instead, these steps or phases can be performed at different moments, the order of execution of these steps or phases is not necessarily performed in order, instead, the order of execution of these steps or phases can be performed in turn or alternately with other steps or at least a part of steps or phases in other steps.

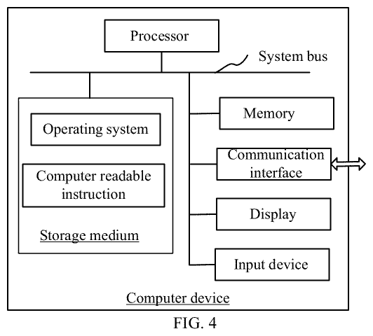

In one embodiment, a computer device is provided, this computer device may be a terminal device, and a schematic diagram of the internal structure of the computer device may be as shown in FIG. 3. The computer device includes a processor, a memory, a communication interface, a display screen and an input device, which are connected through a system bus. The processor of the computer device is configured to provide computing and control capabilities. The memory of the computer device includes a non-volatile storage medium or a volatile storage medium, and an internal memory. The non-volatile storage medium or the volatile storage medium stores an operating system and a computer readable instruction. The internal memory provides an environment for operating the operating system and the computer readable instructions in the non-volatile storage medium. The communication interface of the computer device is configured to communicate with external terminal devices in a wired or wireless manner, and the wireless manner may be implemented by Wi-Fi, a carrier's network, an NFC (Near Field Communication), or other technologies. The computer readable instructions is configured to, when being executed by a processor, implement a method for rendering GIS point data. The display screen of the computer device may be a LCD (Liquid Crystal Display) screen or be an electronic ink display screen. The input device of the computer device may be a touch layer covered on the display screen, the input device may also be a key, a trackball, or a touch pad provided on the housing of the computer device, the input device may also be an external keyboard, a touchpad, a mouse, etc.

The person of ordinary skill in the art will be appreciated that, the structure shown in FIG. 4 is only a block diagram of a structure of some parts associated with the technical solutions of the present application, and should not be constituted as limitations to the computer device which the technical solutions of the present application are applied on, the computer device may include more or less components than the components shown in FIG. 4, or combine some components, or has different components with different arrangements.

A computer device, including a memory and one or a plurality of processor(s), the memory stores a computer readable instruction, that, when being executed by the one or plurality of processor(s), causes the one or plurality of processor(s) to perform following steps of:

receiving a rendering instruction that carries a geographic region range to be rendered;

selecting GIS point data corresponding to the geographic region range;

generating a canvas object corresponding to the selected GIS point data by execution of a canvas object generation thread; and

displaying the generated canvas object on a screen by execution of a display thread, and continuing to obtain a remaining GIS point data and generating a canvas object corresponding to the remaining GIS point data by execution of the canvas object generation thread when or after the canvas object is displayed.

In one embodiment, the one or plurality of processor(s) is/are configured to execute the computer readable instruction to realize the step of continuing to obtain the remaining GIS point data and generating the canvas object corresponding to the remaining GIS point data by execution of the canvas object generation thread by:

obtaining a new GIS point data from the remaining GIS point data in an ascending order of distance from the geographic region range by execution of the canvas object generation thread; and

generating a new canvas object according to the obtained new GIS point data.

In one embodiment, the one or plurality of processor(s) is/are configured to execute the computer readable instruction to realize the step of generating the canvas object by:

classifying the obtained GIS point data according to a preset classification; and

obtaining data sets corresponding to classifications of the obtained GIS point data, and selecting graphic files corresponding to the obtained data sets; and

encapsulating the graphic file with GIS point data in the data sets corresponding to the classifications to obtain the canvas object.

In one embodiment, after the step of displaying the generated canvas object on the screen by execution of the display thread, the one or plurality of processor(s) is/are further configured to execute the computer readable instruction to perform steps of:

storing the canvas object displayed on the screen in a memory;

after the step of selecting the corresponding GIS point data according to the geographic region range, the one or plurality of processor(s) is/are further configured to perform steps of:

determining whether the GIS point data corresponding to the geographic region range corresponds to the canvas object stored in the memory; and

reading the corresponding canvas object from the memory directly when the GIS point data corresponding to the geographic region range corresponds to the canvas object stored in the memory; or continuing to generate, by execution of the canvas object generation thread, the canvas object corresponding to the selected GIS point data, when the GIS point data corresponding to the geographic region range does not correspond to the canvas object stored in the memory.

In one embodiment, the one or plurality of processor(s) is/are configured to execute the computer readable instruction to realize the step of determining whether the GIS point data corresponding to the geographic region range corresponds to the canvas object stored in the memory by:

comparing the geographic region range with a geographic region range corresponding to a stored canvas to obtain an overlapped region;

determining whether there is a GIS point data in the overlapped region; and

extracting, if there is the GIS point data in the overlapped region, the canvas object corresponding to the GIS point data in the overlapped region from the memory and continuing to query whether there exists a canvas object corresponding to a GIS point data in an unoverlapped region in the memory.

In one embodiment, before the step of determining whether the GIS point data corresponding to the geographic region range corresponds to the canvas object stored in the memory, the one or plurality of processor(s) is/are further configured to execute the computer readable instruction to perform steps of:

determining whether all canvas objects corresponding to the GIS point data have been generated; and

reading the canvas objects corresponding to the GIS point data from the memory directly, if all canvas objects corresponding to the GIS point data have been generated.

In one embodiment, when executing the computer readable instruction, the one or plurality of processor(s) is/are further configured to perform following steps of:

determining, when a zoom instruction is received, a degree of adjustment corresponding to the zoom instruction;

obtaining an original graphic size of each of the graphic files corresponding to the data sets;

adjusting the original graphic size according to the degree of adjustment to obtain a new graphic file; and

replacing the original graphic file with the new graphic file.

A computer readable storage medium which stores a computer readable instruction, that, when being executed by one or plurality of processor(s), cause the one or plurality of processor(s) to perform following steps of:

receiving a rendering instruction that carries a geographic region range to be rendered;

selecting GIS point data corresponding to the geographic region range;

generating, by execution of a canvas object generation thread, a canvas object corresponding to the selected GIS point data; and

displaying the generated canvas object on a screen by execution of a display thread, and continuing to obtain a remaining GIS point data and generating a canvas object corresponding to the remaining GIS point data by execution of the canvas object generation thread when or after the canvas object is displayed.

In one embodiment, the computer readable instruction is configured to, when being executed by the one or plurality of processor(s), cause the one or plurality of processor(s) to realize the step of: continuing to obtain the remaining GIS point data and generating the canvas object corresponding to the remaining GIS point data by execution of the canvas object generation thread by:

obtaining a new GIS point data from the remaining GIS point data in an ascending order of distance from the geographic region range by execution of the canvas object generation thread; and

generating a new canvas object according to the obtained new GIS point data.

In one embodiment, the computer readable instruction is configured to, when being executed by the one or plurality of processor(s), cause the one or plurality of processor(s) to realize the step of generating the canvas object by:

classifying the obtained GIS point data according to a preset classification; and

obtaining a set corresponding to a classification of the obtained GIS point data, and selecting a graphic file corresponding to the obtained set; and

encapsulating the graphic file with GIS point data in the sets corresponding to the classifications to obtain the canvas object.

In one embodiment, after the step of displaying the generated canvas object on the screen by execution of the display thread, the computer readable instruction is further configured to, when being executed by the one or plurality of processor(s), cause the one or plurality of processor(s) to perform step of: storing the canvas object displayed on the screen in a memory; after the step of selecting the corresponding GIS point data according to the geographic region range, the computer readable instruction is further configured to, when being executed by the one or plurality of processor(s), cause the one or plurality of processor(s) to perform step of: determining whether the GIS point data corresponding to the geographic region range corresponds to the canvas object stored in the memory; and reading the corresponding canvas object from the memory directly when the GIS point data corresponding to the geographic region range corresponds to the canvas object stored in the memory; or continuing to generate the canvas object corresponding to the selected GIS point data by execution of the canvas object generation thread, when the GIS point data corresponding to the geographic region range does not correspond to the canvas object stored in the memory.

In one embodiment, the computer readable instruction is configured to, when being executed by the one or plurality of processor(s), cause the one or plurality of processor(s) to realize the step of determining whether the GIS point data corresponding to the geographic region range corresponds to the canvas object stored in the memory by: comparing the geographic region range with a geographic region range corresponding to a stored canvas to obtain an overlapped region; determining whether there is a GIS point data in the overlapped region; and extracting, if there is the GIS point data in the overlapped region, the canvas object corresponding to the GIS point data in the overlapped region from the memory, and continuing to query whether there exists a canvas object corresponding to a GIS point data in an unoverlapped region in the memory.

In one embodiment, before the step of determining whether the GIS point data corresponding to the geographic region range corresponds to the canvas object stored in the memory, the computer readable instruction is further configured to, when being executed by the one or plurality of processor(s), cause the one or plurality of processor(s) to realize the step of: determining whether all canvas objects corresponding to the GIS point data have been generated; and reading the canvas objects corresponding to the GIS point data from the memory directly, if all canvas objects corresponding to the GIS point data have been generated.

In one embodiment, the computer readable instruction is further configured to, when being executed by the one or plurality of processor(s), cause the one or plurality of processor(s) to realize the step of: determining, when a zoom instruction is received, a degree of adjustment of image corresponding to the zoom instruction; obtaining an original graphic size of each of the graphic files corresponding to the data sets; adjusting the original graphic size according to the degree of adjustment of image to obtain a new graphic file; and replacing the original graphic file with the new graphic file.

The person of ordinary skilled in the art may be aware of that, a computer program can be used to instruct relevant hardware to accomplish a whole or a part of the flow process for implementing the method embodiments of the present application. The computer program may be stored in a computer readable storage medium, when the computer program is executed, the steps in the various method embodiments described above may be included. Any reference to the memory, the storage, the databases, or other media used in the embodiments provided by the present application may include at least one of the non-volatile memory and the volatile memory. The non-volatile memory may include ROM (Read Only Memory), magnetic tap, floppy disk, flash memory or optical memory. The volatile memory may include RAM (Random Access Memory) or external cache memory. By way of illustration instead of limitation, RAM can be in a variety of forms such as SRAM (Static Random Access Memory), etc.

The various technical features in the embodiments described above may be combined arbitrarily, for the convenience of description, not all possible combinations of the various technical features in the embodiments described above are described; however, the combinations of these technical features should all be considered as falling within the protection scope of the description as long as they are not contradicted with each other.

Some implementation methods of the present application are described in the embodiments described above, and these implementation modes are described definitely and in detail, but should not be interpreted as limitations to the patent protection scope of the present application. It should be noted that, for the person of ordinary skill in the art, some modifications and improvements can also be made without breaking away from the inventive concept of the present application, and these modifications and improvements are all included in the protection scope of the present application. Thus, the protection scope of the present application should be determined by the annexed claims.

1. A method for rendering GIS point data, comprising steps of:
receiving a rendering instruction that carries a geographic region range to be rendered;
selecting GIS point data corresponding to the geographic region range;
generating a canvas object corresponding to the selected GIS point data by execution of a canvas object generation thread; and
displaying the generated canvas object on a screen by execution of a display thread, and continuing to obtain a remaining GIS point data, and generating a canvas object corresponding to the remaining GIS point data by execution of the canvas object generation thread, when or after the canvas object is displayed.

2. The method according to claim 1, wherein the step of continuing to obtain the remaining GIS point data and generating the canvas object corresponding to the remaining GIS point data by execution of the canvas object generation thread comprises steps of:
obtaining a new GIS point data from the remaining GIS point data in an ascending order of distance from the geographic region range by execution of the canvas object generation thread; and
generating a new canvas object according to the obtained new GIS point data.

3. The method according to claim 1, wherein the step of generating the canvas object comprises steps of:
classifying the obtained GIS point data according to a preset classification; and
obtaining a set corresponding to a classification of the obtained GIS point data, and selecting a graphic file corresponding to the obtained set; and
encapsulating the graphic file with each GIS point data in the sets corresponding to the classifications to obtain the canvas object.

4. The method according to claim 1, wherein after the step of displaying the generated canvas object on the screen by execution of the display thread, the method further comprises steps of:
storing the canvas object displayed on the screen in a memory;
after the step of selecting the corresponding GIS point data according to the geographic region range, the method further comprises steps of:
determining whether the GIS point data corresponding to the geographic region range corresponds to the canvas object stored in the memory; and
reading the corresponding canvas object from the memory directly when the GIS point data corresponding to the geographic region range corresponds to the canvas object stored in the memory; or continuing to generate the canvas object corresponding to the selected GIS point data by execution of the canvas object generation thread, when the GIS point data corresponding to the geographic region range does not correspond to the canvas object stored in the memory.

5. The method according to claim 4, wherein the step of determining whether the GIS point data corresponding to the geographic region range corresponds to the canvas object stored in the memory comprises steps of:
comparing the geographic region range with a geographic region range corresponding to a stored canvas to obtain an overlapped region;
determining whether there is a GIS point data in the overlapped region; and
extracting, if there is the GIS point data in the overlapped region, the canvas object corresponding to the GIS point data in the overlapped region from the memory and continuing to query whether there exists a canvas object corresponding to a GIS point data in an unoverlapped region in the memory.

6. The method according to claim 4, wherein before the step of determining whether the GIS point data corresponding to the geographic region range corresponds to the canvas object stored in the memory, the method further comprises steps of:
determining whether all canvas objects corresponding to the GIS point data have been generated; and
reading the canvas objects corresponding to the GIS point data from the memory directly, if all canvas objects corresponding to the GIS point data have been generated.

7. The method according to claim 3, further comprising steps of:
determining, when a zoom instruction is received, a degree of adjustment of image corresponding to the zoom instruction;
obtaining an original graphic size of each of the graphic files corresponding to the sets;
adjusting the original graphic size according to the degree of adjustment of image to obtain a new graphic file; and
replacing the original graphic file with the new graphic file.

8. (canceled)

9. A computer device, comprising a memory and one or a plurality of processor(s), the memory stores a computer readable instruction, that, when being executed by the one or plurality of processor(s), causes the one or plurality of processor(s) to perform following steps of:
receiving a rendering instruction that carries a geographic region range to be rendered;
selecting GIS point data corresponding to the geographic region range;
generating a canvas object corresponding to the selected GIS point data by execution of a canvas object generation thread; and
displaying the generated canvas object on a screen by execution of a display thread, and continuing to obtain a remaining GIS point data and generating a canvas object corresponding to the remaining GIS point data by execution of the canvas object generation thread, when or after the canvas object is displayed.

10. The computer device according to claim 9, wherein the one or plurality of processor(s) is/are configured to execute the computer readable instruction to realize the step of continuing to obtain the remaining GIS point data and generating the canvas object corresponding to the remaining GIS point data by execution of the canvas object generation thread by:
obtaining a new GIS point data from the remaining GIS point data in an ascending order of distance from the geographic region range by execution of the canvas object generation thread; and
generating a new canvas object according to the obtained new GIS point data.

11. The computer device according to claim 9, wherein the one or plurality of processor(s) is/are configured to execute the computer readable instruction to realize the step of an approach of generating the canvas object by:
classifying the obtained GIS point data according to a preset classification; and
obtaining a set corresponding to a classification of the obtained GIS point data, and selecting a graphic file corresponding to the obtained sets; and
encapsulating the graphic file with each GIS point data in the set corresponding to the classification to obtain the canvas object.

12. The computer device according to claim 9, wherein after the step of displaying the generated canvas object on the current screen by execution of the display thread, the one or plurality of processor(s) is/are further configured to execute the computer readable instruction to perform steps of:
storing the canvas object displayed on the screen in a memory;
wherein after the step of selecting the corresponding GIS point data according to the geographic region range, the one or plurality of processor(s) is/are further configured to perform steps of:
determining whether the GIS point data corresponding to the geographic region range corresponds to the canvas object stored in the memory; and
reading the corresponding canvas object from the memory directly when the GIS point data corresponding to the geographic region range corresponds to the canvas object stored in the memory; or continuing to generate the canvas object corresponding to the selected GIS point data by execution of the canvas object generation thread, when the GIS point data corresponding to the geographic region range does not correspond to the canvas object stored in the memory.

13. The computer device according to claim 12, wherein the one or plurality of processor(s) is/are configured to execute the computer readable instruction to realize the step of determining whether the GIS point data corresponding to the geographic region range corresponds to the canvas object stored in the memory by:
comparing the geographic region range with a geographic region range corresponding to a stored canvas to obtain an overlapped region;
determining whether there is a GIS point data in the overlapped region; and
extracting, if there is the GIS point data in the overlapped region, the canvas object corresponding to the GIS point data in the overlapped region from the memory, and continuing to query whether there exists a canvas object corresponding to a GIS point data in an unoverlapped region in the memory.

14. The computer device according to claim 12, wherein before the step of determining whether the GIS point data corresponding to the geographic region range corresponds to the canvas object stored in the memory, the one or plurality of processor(s) is/are further configured to execute the computer readable instruction to perform steps of:
determining whether all canvas objects corresponding to the GIS point data have been generated; and
reading the canvas objects corresponding to the GIS point data from the memory directly, if all canvas objects corresponding to the GIS point data have been generated.

15. The computer device according to claim 11, wherein when executing the computer readable instruction, the one or plurality of processor(s) is/are further configured to perform following steps of:
determining, when a zoom instruction is received, a degree of adjustment of image corresponding to the zoom instruction;
obtaining an original graphic size of each of the graphic files corresponding to the data sets;
adjusting the original graphic size according to the degree of adjustment of image to obtain a new graphic file; and
replacing the original graphic file with the new graphic file.

16. A computer readable storage medium which stores a computer readable instruction, that, when being executed by one or plurality of processor(s), cause the one or plurality of processor(s) to perform following steps of:
receiving a rendering instruction that carries a geographic region range to be rendered;
selecting GIS point data corresponding to the geographic region range;
generating, by execution of a canvas object generation thread, a canvas object corresponding to the selected GIS point data; and
displaying the generated canvas object on a screen by execution of a display thread, and continuing to obtain a remaining GIS point data and generating a canvas object corresponding to the remaining GIS point data by execution of the canvas object generation thread when or after the canvas object is displayed.

17. The storage medium according to claim 16, wherein the computer readable instruction is configured to, when being executed by the one or plurality of processor(s), cause the one or plurality of processor(s) to realize the step of: continuing to obtain the remaining GIS point data and generating the canvas object corresponding to the remaining GIS point data by execution of the canvas object generation thread by:
obtaining a new GIS point data from the remaining GIS point data in an ascending order of distance from the geographic region range by execution of the canvas object generation thread; and
generating a new canvas object according to the obtained new GIS point data.

18. The storage medium according to claim 16, wherein the computer readable instruction is configured to, when being executed by the one or plurality of processor(s), cause the one or plurality of processor(s) to perform the step of generating the canvas object by:
classifying the obtained GIS point data according to a preset classification; and
obtaining a set corresponding to a classification of the obtained GIS point data, and selecting a graphic file corresponding to the obtained set; and
encapsulating the graphic file with each GIS point data in the set corresponding to the classification to obtain the canvas object.

19. The storage medium according to claim 16, wherein after the step of displaying the generated canvas object on the screen by execution of the display thread, the computer readable instruction is further configured to, when being executed by the one or plurality of processor(s), cause the one or plurality of processor(s) to perform step of:
storing the canvas object displayed on the screen in a memory;
wherein after the step of selecting the corresponding GIS point data according to the geographic region range, the computer readable instruction is further configured to, when being executed by the one or plurality of processor(s), cause the one or plurality of processor(s) to perform step of:
determining whether the GIS point data corresponding to the geographic region range corresponds to the canvas object stored in the memory; and
reading the corresponding canvas object from the memory directly when the GIS point data corresponding to the geographic region range corresponds to the canvas object stored in the memory; or continuing to generate the canvas object corresponding to the selected GIS point data by execution of the canvas object generation thread, when the GIS point data corresponding to the geographic region range does not correspond to the canvas object stored in the memory.

20. The storage medium according to claim 18, wherein the computer readable instruction is configured to, when being executed by the one or plurality of processor(s), cause the one or plurality of processor(s) to realize the step of: determining whether the GIS point data corresponding to the geographic region range corresponds to the canvas object stored in the memory by:
comparing the geographic region range with a geographic region range corresponding to a stored canvas to obtain an overlapped region;
determining whether there is a GIS point data in the overlapped region; and
extracting, if there is the GIS point data in the overlapped region, the canvas object corresponding to the GIS point data in the overlapped region from the memory, and continuing to query whether there exists a canvas object corresponding to a GIS point data in an unoverlapped region in the memory.
